(19) United States
(12) Patent Application Publication
(10) Pub. No.: US 2013/0291011 A1
(43) Pub. Date: Oct. 31, 2013

(54) TRANSCODING SERVER AND METHOD FOR OVERLAYING IMAGE WITH ADDITIONAL INFORMATION THEREIN

(71) Applicants: Electronics and Telecommunications Research Institute, (US); KT CORPORATION, Seongnam-si Gyeonggi-do (KR)

(72) Inventors: Il-Hong SHIN, Daejeon (KR); Chang-Woo YOON, Daejeon (KR); Hyun-Woo LEE, Daejeon (KR); Won RYU, Daejeon (KR); Young-Dal KWON, Seoul (KR); Sang-Hoon HAN, Gwangmyeong-si Gyeonggi-do (KR); Sun-Jong KWON, Seoul (KR)

(73) Assignees: KT Corporation, Seongnam-si Gyeonggi-do (KR); Electronics and Telecommunications Research Institute, Daejeon (KR)

(21) Appl. No.: 13/873,427

(22) Filed: Apr. 30, 2013

(30) Foreign Application Priority Data
Apr. 30, 2012 (KR) 10-2012-0045780

(51) Int. Cl. H04N 21/81

(52) U.S. Cl. CPC H04N 21/81
USPC 725/32

(57) ABSTRACT

A transcoding server is provided, and the transcoding server includes a receiving unit configured to receive image data and additional information via a communication network; an additional middleware configured to process the received additional information; a decoding unit configured to decode the received image data; an overlay-mixer configured to generate integrated image data by overlaying the decoded image data with the processed additional information; an encoding unit configured to encode the generated integrated data image; and a transmitting unit configured to transmit the encoded integrated image data to one or more terminals.

### CROSS-REFERENCE TO RELATED APPLICATION

This application claims the benefit under 35 U.S.C. §119(a) of Korean Patent Application No. 10-2012-0045780, filed on Apr. 30, 2012, the entire disclosure of which is incorporated herein by reference for all purposes.

### BACKGROUND

1. Field

The following description relates to an apparatus and a method for processing images, and, more particularly, to an apparatus and a method for overlaying an image with additional image when remotely displaying images on a screen.

2. Description of the Related Art

As the Internet is widely used and digital broadcasting technologies have been developed, more people are now able to enjoy bi-directional broadcast services.

With regard to the bi-directional broadcast service, a bi-directional broadcast receiver (for example, an Internet Protocol Television (IPTV), a Digital Multimedia Broadcasting (DMB) receiver and a Set Top Box) receives information, images and broadcasts on a high-speed Internet. The bi-directional broadcast service enables a user to surf the Internet, watch a movie, enjoy home-shopping and home-banking, play an online game, download MP3 files, and the like.

In particular, in the case of a data broadcasting service in which additional information is provided, it is common that the additional information is overlaid on an image or displayed in a different window on the screen.

Meanwhile, services based on a thin-client or a zero-client are now popular due to the development of cloud technologies and communication networks. Yet, services based on a thin-zero client are something unfamiliar to ordinary people. A thin-zero client requires a server to computes complex data while it does simple data.

Therefore, a thin-zero client does not need an Operating System (OS) and a middleware to overlay an image with additional information.

### SUMMARY

The following description relates to a transcoding server and a method for overlaying an image with additional information therein to reduce computing operations inside of a terminal.

Specifically, the following description relates to a transcoding server and a method for overlaying an image with additional information to reduce computing operation in a server.

In one general aspect of the present invention, a transcoding server is provided, and the transcoding includes a receiving unit configured to receive image data and additional information via a communication network; an additional middleware configured to process the received additional information; a decoding unit configured to decode the received image data; an overlay-mixer configured to generate integrated image data by overlaying the decoded image data with the processed additional information; an encoding unit configured to encode the generated integrated data image; and a transmitting unit configured to transmit the encoded integrated image data to one or more terminals.

In another general aspect of the present invention, a method for overlaying an image with additional information in a transcoding server accessible to one or more terminals is provided, and the method includes receiving image data and additional information; decoding the received image data; generating an integrated image data by overlaying the decoded image data with the additional information; encoding the integrated image data; and transmitting the encoded integrated image data to one or more terminals.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of a conventional system for overlaying images;

FIG. 2 is a diagram illustrating a configuration of a system including a transcoding server which overlays an image with additional information according to an exemplary embodiment of the present invention;

FIG. 3 is a configuration of a transcoding server according to an exemplary embodiment of the present invention;

FIG. 4 is a diagram illustrating operations of a encoder according to an exemplary embodiment of the present invention; and

FIG. 5 is a flow chart illustrating a method for overlaying an image with additional information according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

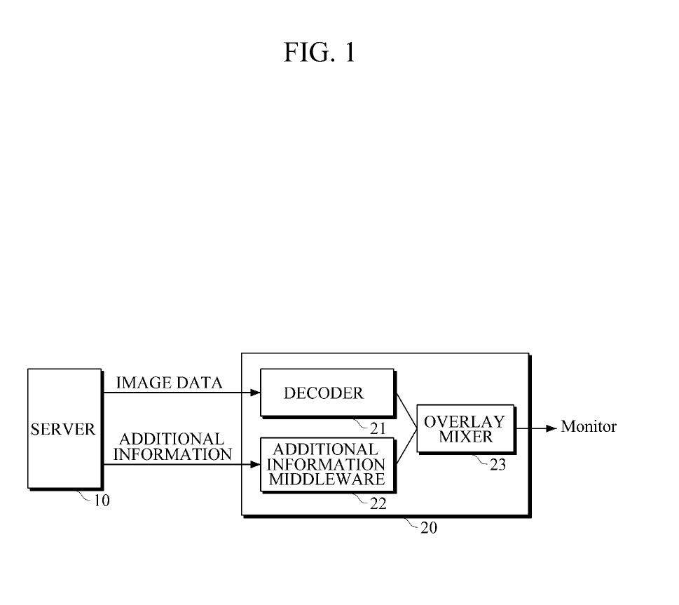

FIG. 1 is a diagram illustrating a configuration of a conventional system for overlaying image additional information.

Referring to FIG. 1, when a terminal 20 receives image data and additional information about the image data from a server 10, a decoding unit 21 decodes compressed image- or audio-codec image from the received image data, and an additional information middleware 22 processes the additional information. In addition, a terminal overlay mixer 23 overlays the additional information, output from the additional information middleware 22, on the image data, output from the decoding unit 21. At this time, the image data overlaid with the additional data, that is, integrated image data, is displayed on an embedded monitor or an external monitor so that a user is able to see the image data visually.

However, since the terminal 20 overlay-mixes image data with additional information, a significant load of calculation occurs in the terminal 20. It is a major obstacle to configure a thin-zero client.

For this reason, the present invention provides a transcoding server which overlay-mixes image data as a terminal does.

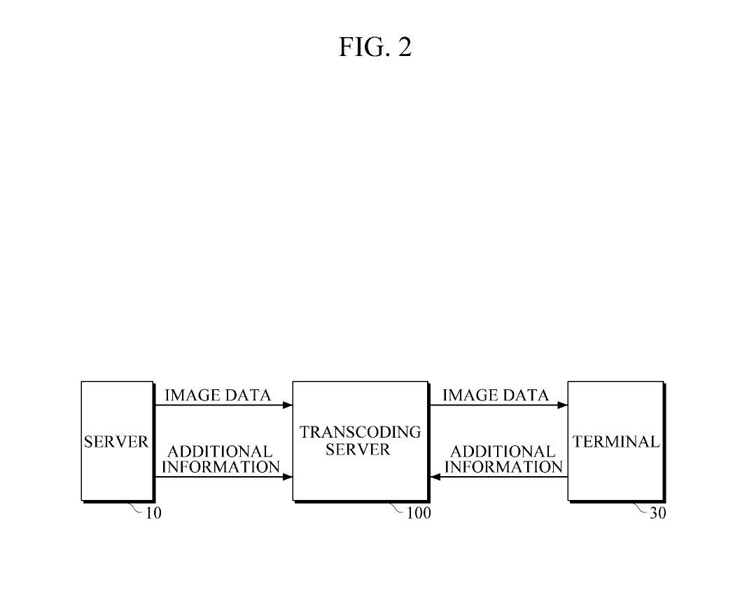

FIG. 2 is a diagram illustrating a configuration of a system including a transcoding server which overlays additional information according to an exemplary embodiment of the present invention.

FIG. 2 illustrates a case where a server 10, a transcoding server 100 and a terminal 30 are connected to each other via a communication network. The server 10, the transcoding server 100 and the terminal 30 are configured to be physically separated in FIG. 2, but it is merely exemplary and the present invention is not limited thereto. That is, the server 10 and the transcoding server 100 may be included in the same hardware.

The server 10 transmits image data and additional information to the transcoding server 100 via a communication network. Herein, the image data refers to compressed data and may include video data and audio data.

The transcoding server 100 receives the image data and the additional information, overlays the image data with the additional information, and outputs the image overlaid with the additional information to the terminal 30.

The terminal 30 may receive the image data overlaid with the additional information, that is, an integrated image data, from the transcoding server 100 via a communication network, and display the integrated image not only on a screen of a mobile communication terminal, such as a Personal Digital Assistant (PDA), a smart phone and a navigation terminal, but also on a screen of a desktop, a laptop or a tablet PC. According to an exemplary embodiment of the present invention, the terminal 30 may simply decode image data without processing additional information in a middleware. Accordingly, a terminal may be configured to include a firmware and an image decoder, without the need of an Operating System (OS) and a Middleware which are indispensable for a conventional terminal.

However, as the transcoding server 100 may be under a heavy load as image data is not only overlayed but also decoded in the transcoding server 100. To prevent a heavy load, the transcoding server 100 overlay-mixes image data only upon a request from the terminal 30, and simply bypasses image data in response to not receiving a request from the terminal 30. That is, the transcoding server 100 decodes image data only in the case where the image data needs to be overlaid with additional information, and, if the request for the additional information is terminated, transmits to the terminal 30 the image data the same as it was received. In this manner, it is possible to reduce loads led by decoding the images, considering that a user does not always request additional information while watching a video.

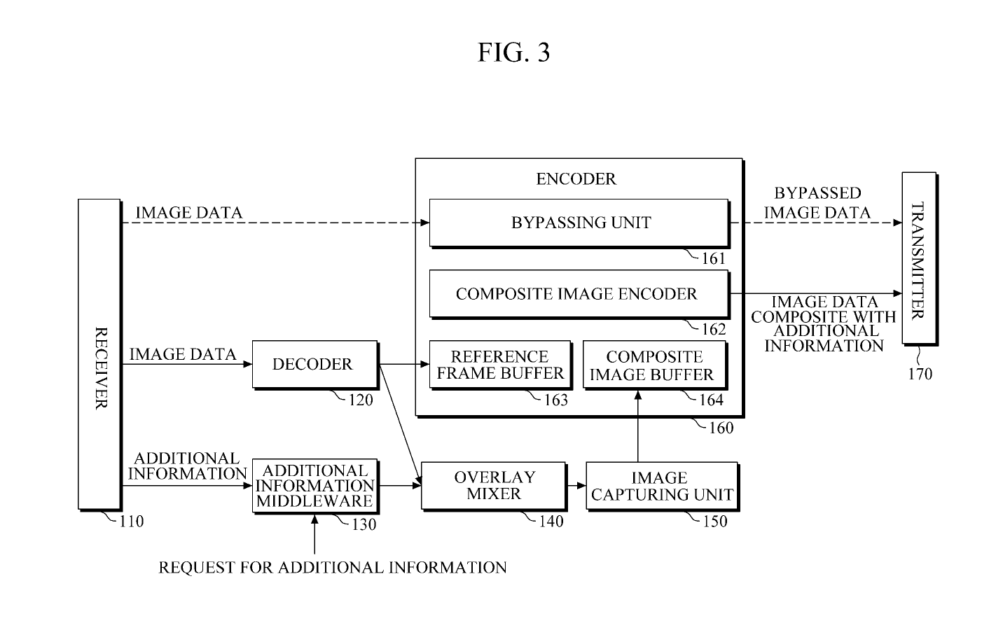

FIG. 3 is a diagram illustrating a configuration of a transcoding server according to an exemplary embodiment of the present invention.

Referring to FIG. 3, a transcoding server 100 includes a receiving unit 110, a decoding unit 120, an additional information middleware 130, an overlay-mixer 140, an image capturing unit 150, an encoding unit 160 and a transmitting unit 170.

The receiving unit 110 performs a communication interface function to communicate with a server 10, and a demultiplexing function to input received image data to the decoding unit 120, the additional information middleware 130 and the encoding unit 160. That is, the receiving unit 110 receives image data and additional information transmitted on the Internet or a wireless communication network. In addition, the received image data is input both in the decoding unit 120 and the encoding unit 160, and the received additional information is input in the additional information middleware 130.

The decoding unit 120 decodes the received image data and outputs the decoded image data. That is, the decoding unit 120 decodes video data and audio data separately and outputs the decoded video data and the decoded audio data.

The additional information middleware 130 processes the additional information transmitted from the server 10 only when the terminal 30 requests the additional information.

The overlay-mixer 140 overlays the image data, received from the decoding unit 120, with the additional information received from the additional information middleware 130. If no additional information is received from the additional middleware 130, the overlay-mixer 140 does not operate. That is, only when the terminal 30 requests additional information, the additional information is overlaid with corresponding image data.

The image capturing unit 150 captures the image which is overlaid with the additional information by the overlay-mixer 140, and transmits the captured image overlaid with the additional information to the encoding unit 160.

The encoding unit 160 encodes the image overlaid with the additional information, that is, an integrated image data, and outputs the encoded integrated image data. According to an exemplary embodiment of the present invention, the encoding unit 160 decodes image data upon a request for additional information, and simply bypasses the image data if there is no request for additional information. That is, if receiving the integrated image from the image capturing unit 150, the encoding unit 160 encodes the integrated image data. However, if image data is not received from the image capturing unit 150, the encoding unit 160 bypasses the received image data which is not decoded.

To this end, the encoding unit 160 includes a bypasser 161, an integrated image encoder 162, a reference frame buffer 163 and an integrated image buffer 164.

The bypasser 161 bypasses the received image data. That is, since image data received directly from the receiving unit 110 is not decoded, the image data is transmitted directly to the terminal 30 through the transmitting unit 170 without being encoded.

The integrated image encoder 162 encodes the image overlaid with additional information, that is, an integrated image, and transmits the encoded integrated image to the terminal via the transmitting unit 170.

The reference frame buffer 163 receives the image data decoded by the decoding unit 120. Even if there is no request for additional information, decoded image data may be stored all the time in the reference frame buffer 163 to help synchronize operations of the encoding unit 160 and the decoding unit 120. That is, the integrated image encoder 162 encodes a frame that is the same as a decoded frame stored in the reference frame buffer 163.

The integrated image buffer 164 stores the integrated image received from the image capturing unit 150. In response, the integrated image encoder 162 encodes the integrated image stored in the integrated image buffer 164.

The transmitting unit 170 performs a communication function of transmitting received image data to the terminal 30 on a wireless or wired communication network, and a multiplexing function of transmitting either received image data, which is bypassed, or integrated image data to the terminal 30. If integrated image data, that is, image data overlaid with additional information, is received, the transmitting unit 170 transmits the integrated data to the terminal 30, while transmitting bypassed image data to the terminal if no integrated data is received.

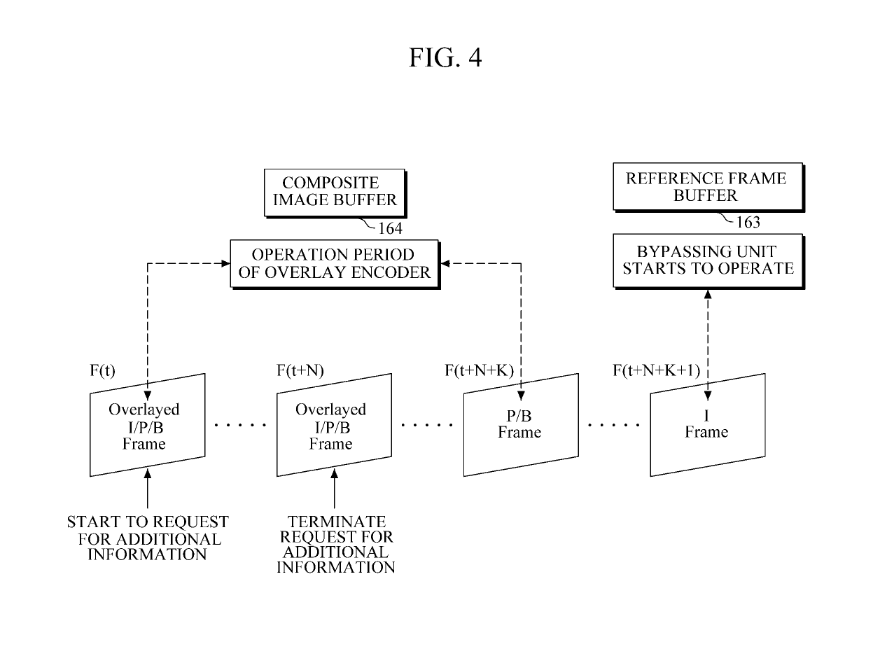

Meanwhile, if the encoding unit 160 bypasses received image data when there is no request for additional information, an image break-up may be caused due to structural characteristics of images. At a time when the request for additional information is terminated, the decoding unit 120 decodes a currently-received bit stream with reference to the image data overlaid with the additional information, which is considered as previous information, thereby resulting in an image breakup. Detailed description about the image break-up will be provided with reference to FIG. 4.

FIG. 4 is a diagram illustrating operations of a decoding unit according to an exemplary embodiment of the present invention.

An image frame may be one of I,P and B frames. In particular, an I frame is independent of a previous frame and is referred to as Instantaneous Decoder Refresh (IDR). When changing a channel during a live broadcast, the I frame is searched to be decoded.

A P or B frame is used to increase compression rate based on information about a previously decoded frame. That is, if information about the previous frame changes, a P or B frame needs to be generated by performing an encoding process thereon, because the P or B frame relates to the information about the previous frame.

For this reason, although it is not necessary to overlay an image with additional information when a request for the additional information is terminated, a decoding unit 120 decodes a P or B frame and inputs the decoded P or B frame in an integrated image buffer 164. In addition, at a time from when the request is terminated till a next I frame comes up, an integrated image encoder 162 operates. That is, as illustrated in FIG. 4, when an I frame appears, information about a decoded frame is input in the reference frame buffer 163 but the integrated image encoder 162 stops operating.

To put it simply, if there is a request for additional information, information about the current image, which is overlaid with the additional information, is input in a video input buffer, and a P or B frame is compressed with reference to a reference frame buffer 163. That is, at a time when the request for additional information is terminated, the transcoding server performs an encoding process using a decoding unit and an encoding unit until a next I frame comes up, and bypasses bit streams which come after the next I frame. At this time, the decoding unit is always in operation while the encoding unit operates only in response to the request for additional information. In this way, loads on the transcoding server may reduce significantly.

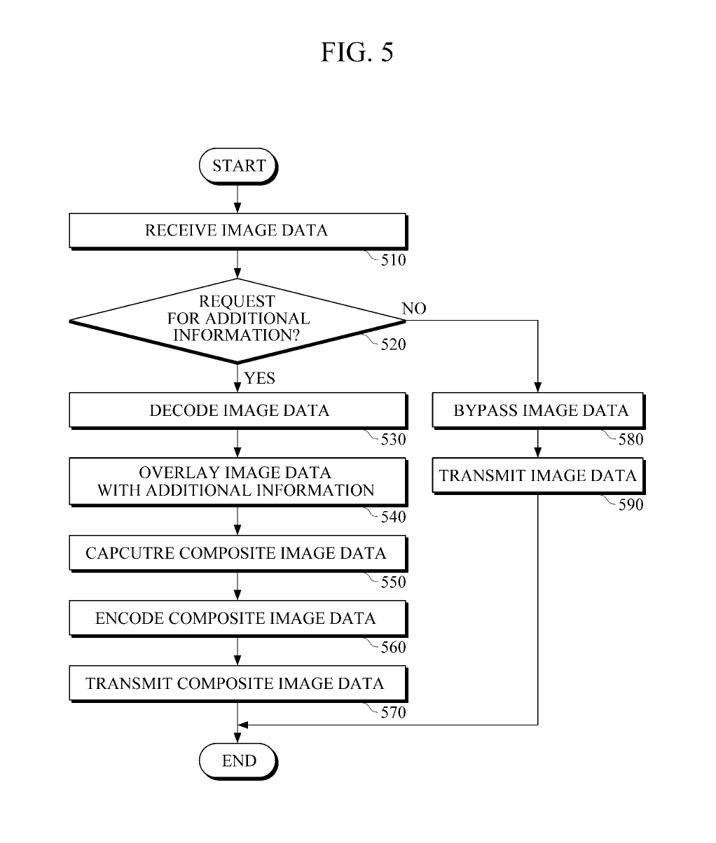

FIG. 5 is a flow chart illustrating a method for overlaying an image with additional data according to an exemplary embodiment of the present invention.

Referring to FIG. 5, a transcoding server receives image data and additional information in 510. In addition, the transcoding server determines whether a user requests additional information in 520.

If it is determined that a user requests additional information in 520, the transcoding server decodes the received image data in 530 and overlays the decoded image data with the additional information in 540.

In addition, an integrated image, that is, the image overlaid with the additional image, is captured in 550, and the integrated image is decoded in 560. At this time, frames of the integrated image data is decoded with reference to information about the above decoded frame to be in sync with the encoding process for the integrated image data. In addition, if the request for the additional information is terminated, the integrated image data is decoded until a frame unrelated to previously-encoded frames is output. In addition, the transcoding server transmits the integrated image data to one or more terminals in 570.

Meanwhile, if it is determined in 520 that there is no request for additional information, the transcoding server bypasses the image data in 580. Although not illustrated in the drawings, received image data may be decoded and then stored even though corresponding additional information is not requested even when there is no request for additional information. In this way, bypassed image data is synchronized with decoded image data.

In addition, the transcoding server transmits the bypassed image data to one or more terminals in 590.

The present invention is able to configure a thin-zero client by overlaying image data with additional information in an additional transcoding server and then transmitting the image data overlaid with the additional information.

In addition, the present invention is able to reduce loads led by the operation of overlaying image data with additional information in a transcoding server since the operation is performed only upon a request for the additional information.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A transcoding server comprising:
a receiving unit configured to receive image data and additional information via a communication network;
an additional middleware configured to process the received additional information;
a decoding unit configured to decode the received image data;
an overlay-mixer configured to generate integrated image data by overlaying the decoded image data with the processed additional information;
an encoding unit configured to encode the generated integrated data image; and
a transmitting unit configured to transmit the encoded integrated image data to one or more terminals.

2. The transcoding server of claim 1, wherein the additional information middleware processes the additional information only upon a request for additional information, and outputs the processed additional information to the overlay-mixer.

3. The transcoding server of claim 1, wherein the encoding unit, in response to a request for additional information, encodes the integrated image data output from the overlay mixing unit and transmits the encoded integrated image data to the transmitting unit, while bypassing the image data output from the receiving unit to be transmitted to the transmitting unit if the request for additional information is terminated.

4. The transcoding server of claim 1, wherein the encoding unit comprises
an integrated image buffer configured to store the integrated image data generated in the overlay-mixer;
an integrated image encoder configured to transmit the integrated image data stored in the integrated image buffer to the transmitting unit; and
a bypasser configured to, if the request for additional information is terminated, bypass the image data output from the receiving unit to be transmitted to the transmitting unit.

5. The transcoding server of claim 4, wherein the encoding unit further comprises
a reference frame buffer configured to store information about the image data decoded in the decoding unit,
wherein the integrated image encoder, in sync with the decoding unit, encodes frames of the integrated image data with reference to the reference frame buffer.

6. The transcoding server of claim 4, wherein, if the request for additional information is terminated, the integrated image encoder encodes the integrated image data until a frame independent of previously-encoded integrated image data is output.

7. A method for overlaying an image with additional information in a transcoding server accessible to one or more terminals, the method comprising:
receiving image data and additional information;
decoding the received image data;
generating an integrated image data by overlaying the decoded image data with the additional information;
encoding the integrated image data; and
transmitting the encoded integrated image data to one or more terminals.

8. The method of claim 7, wherein the encoding of the integrated image data comprises determining whether there is a request for the additional information, and either encoding the integrated image data or bypassing the received image data according to a determination result.

9. The method of claim 8, wherein the encoding of the integrated image data comprises encoding frames of the integrated image with reference to information about the decoded image data, in sync with the decoding of the received image data.

10. The method of claim 8, wherein, if the request for the additional information is terminated, the encoding of the integrated image data comprises encoding the integrated image data until a frame independent of previously-encoded integrated image data is output.
